(19) United States
(12) Patent Application Publication
(10) Pub. No.: US 2020/0250991 A1
(43) Pub. Date: Aug. 6, 2020

(54) METHOD FOR PERFORMING EMERGENCY BRAKING IN A MOTOR VEHICLE AND EMERGENCY BRAKING SYSTEM FOR PERFORMING THE METHOD

(71) Applicant: WABCO GmbH, Hannover (DE)

(72) Inventors: Stephan Kallenbach, Hannover (DE); Oliver Wulf, Neustadt (DE)

(21) Appl. No.: 16/753,805

(22) PCT Filed: Aug. 30, 2018
(86) PCT No.: PCT/EP2018/073387

§ 371 Date: Apr. 6, 2020

(30) Foreign Application Priority Data
Oct. 7, 2017 (DE) 10 2017 009 306.7

(51) Int. Cl. G08G 1/00; B60W 50/04; G05D 1/02

(52) U.S. Cl. CPC G08G 1/22; B60W 50/045; B60W 2554/802; B60W 2555/20; B60W 2554/40; G05D 1/0291

(57) ABSTRACT

A method for arranging individual vehicles in a platoon includes determining a desired longitudinal offset and/or a desired transverse offset for at least one respective individual vehicle by determining at least one wind factor that characterizes how prevailing wind in a vehicle environment acts on the at least one respective individual vehicle of the platoon. The method further includes specifying the desired transverse offset and/or the desired longitudinal offset for the at least one respective individual vehicle of the platoon in dependence upon the at least one wind factor in such a manner that an air resistance acting on the at least one respective individual vehicle of the platoon reduces under the prevailing wind.

### CROSS REFERENCE TO RELATED APPLICATIONS

This application is a U.S. National Phase Application under 35 U.S.C. § 371 of International Application No. PCT/EP2018/073387, filed on Aug. 30, 2018, and claims benefit to German Patent Application No. DE 10 2017 009 306.7, filed on Oct. 7, 2017. The International Application was published in German on Apr. 11, 2019 as WO 2019/068397 under PCT Article 21(2).

### FIELD

The invention relates to a method for arranging vehicles, in particular commercial vehicles, in a platoon, and a control arrangement for performing said method.

### BACKGROUND

In vehicles, in particular commercial vehicles, an interval control system, also referred to as an automatic interval control system or an adaptive cruise control (ACC) system is used, by means of which a desired longitudinal offset predetermined by the driver, i.e. an interval to the vehicle that is travelling ahead in the travel direction of the own vehicle, may be adjusted between the own vehicle and a vehicle that is travelling directly ahead. For this purpose, a brake unit or a drive unit of the own vehicle is controlled by an interval control unit of the interval control system in order to adjust the predetermined desired longitudinal offset.

For the driving operation in a platoon in which multiple vehicles move in a coordinated manner in a convoy, it is conventional practice to provide in the own vehicle a platooning control unit that with the aid of information or data that has been acquired relating to the driving dynamics concerning the own vehicle and the prevailing vehicle environment to adequately control the own vehicle in order to ensure a safe and a fuel-efficient as possible operation of the own vehicle and where appropriate also of other vehicles when traveling in a convoy. For this purpose, in dependence upon the prevailing data relating to the driving dynamics the platooning control unit or a further vehicle controller determines control data and outputs said control data to the brake unit and/or the drive unit in order to operate the own vehicle as calculated and consequently to adjust a desired driving behavior within the platoon. It is thereby possible to adjust the intervals between the vehicles in a platoon to be shorter than in the case of a conventional interval control system since the coordination between the vehicles is enhanced.

US 2016/0054735 A1 discloses a platooning control unit with which the own vehicle may be controlled in a safer and more reliable manner within a platoon, wherein the driving behavior of other vehicles in the vehicle environment of the own vehicle is monitored using sensors. In addition, a wireless data communication between the vehicles of the platoon is provided, via which it is possible to coordinate the driving behavior of the vehicles with one another. Thereby, information relating to the driving dynamics is exchanged and based thereon a desired acceleration rate or a desired velocity is determined by a platooning control unit in the respective vehicle and output to the brake unit or the drive unit in order to adjust a specific desired longitudinal offset between the own vehicle and the respective vehicle traveling ahead.

Furthermore, an air conducting system is disclosed that for the driving operation in a platoon is unfolded and whose shape may be adjusted in dependence upon the velocity and weather. It is also possible to adjust the settings of the air conducting system in dependence upon a position of the vehicle in the platoon.

DE 10 2010 013 647 B4 describes a platoon comprising a master vehicle, which coordinates the platoon, and further vehicles, wherein the master vehicle issues in particular positioning instructions and velocity specifications and thus desired longitudinal offsets to the other vehicles that implement these requirements via the brake unit and/or the drive unit. The requirements are transmitted via a wireless data communication into the individual vehicles, which then implement said requirements in a coordinated manner by means of a platooning control unit accordingly by influencing the brake unit and/or the drive unit.

### SUMMARY

In an embodiment, the present invention provides a method for arranging individual vehicles in a platoon. The method includes determining a desired longitudinal offset and/or a desired transverse offset for at least one respective individual vehicle by determining at least one wind factor that characterizes how prevailing wind in a vehicle environment acts on the at least one respective individual vehicle of the platoon, and specifying the desired transverse offset and/or the desired longitudinal offset for the at least one respective individual vehicle of the platoon in dependence upon the at least one wind factor in such a manner that an air resistance acting on the at least one respective individual vehicle of the platoon reduces under the prevailing wind.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a schematic view of a platoon;

FIGS. 2a, b show a first illustration of wind conditions in the case of platooning;

FIG. 3 shows a second illustration of wind conditions in the case of platooning;

FIG. 4 illustrates an exemplary positioning of vehicles in a platoon; and

FIG. 5 illustrates a flow diagram of a method according to an embodiment.

### DETAILED DESCRIPTION

It is a disadvantage of the aforementioned platooning control systems that only the desired longitudinal offset, i.e. the interval in the travel direction between the respective vehicles is adjusted and this in the case of a side wind acting on the vehicles produces only a slight, if at all, optimization of the fuel economy.

The present disclosure describes a method and a control arrangement for arranging vehicles in a platoon and with which it is possible to ensure a safer and more fuel-efficient operation of the vehicles within the platoon under different wind conditions.

The present disclosure provides for determining a desired longitudinal offset, i.e. an interval between vehicles of a platoon in the travel direction of the relevant vehicles, and/or a desired transverse offset, i.e. an interval between the vehicles of the platoon perpendicular to the travel direction of the relevant vehicles, in dependence upon the environmental conditions, in particular in dependence upon wind factors, with the result that the air resistance that is acting at least upon one of the vehicles is reduced. The air resistance indicates thereby the resistance, which the air that is located in a vehicle environment around the respective vehicle acts against the respective vehicle. The air resistance of a vehicle is in this case in particular dependent upon the dynamics of the air that is surrounding the respective vehicle, i.e. in particular upon a wind speed and/or a wind direction with which the air is moving relative to the vehicle. These dynamics of the air surrounding the respective vehicle can be characterized by the wind factor.

The term a ‘platoon’ is understood in this case to mean a formation of at least two vehicles that are traveling one behind the other in the form of a convoy and whose travel dynamics, by way of example their vehicle velocities and/or actual longitudinal offsets and/or actual transverse offsets and/or their positions are coordinated with one another. The coordination may be achieved by way of example via an alternating observation and/or via a data exchange between the vehicles with the result that an actual longitudinal offset between the individual vehicles may be adjusted that under certain conditions may also be less than a usual safety interval.

As a consequence, the advantage is already provided that in the presence of a true wind (meteorological wind) that has a directional component perpendicular to the travel direction, it is possible to further optimize the driving operation in the lee of the wind within the scope of platooning if on the one hand the desired longitudinal offset is adjusted to suit the determined wind factor but in addition also if a desired transverse offset is determined in dependence upon the wind factor. In order under these conditions to exploit optimally the lee of the wind for generating a smallest possible air resistance on at least one of the vehicles of the platoon, it is therefore advantageous to also provide between two vehicles a correspondingly adjusted desired transverse offset. The influence of the actual longitudinal offset is in fact less in the case of a side wind but also present, since the procedure of adjusting the actual longitudinal offset depending upon the wind condition may have a positive effect on the own vehicle or also on the other vehicles.

With methods described herein, vehicles of the platoon are only arranged or coordinated in a safe and fuel-efficient manner, wherein it is also to be provided that desired positions or desired offsets (longitudinal and/or transverse) of vehicles within the platoon are determined in order to orient the vehicles with respect to one another and/or relative to a traffic lane. Consequently, a specific actual arrangement or orientation of the vehicles with respect to one another is produced if these desired offsets are also adjusted successively. Consequently, the arranging procedure does not include automatically the real or physical positioning of the vehicles with respect to one another, i.e. controlling the actuators in the vehicle so as to implement the desired offsets. This may preferably only be performed in a subsequent step.

In order to determine the optimum desired transverse offset and/or the desired longitudinal offset between the vehicles or the actual effect of the true wind on the respective vehicle, advantageously an apparent wind is to be estimated, said apparent wind being calculated by means of a vector addition of an airflow at a specific vehicle velocity of the respective vehicle and the currently prevailing true wind. Advantageously, the wind factor therefore characterizes the apparent wind since this actually acts on the respective vehicle in a driving situation and within the scope of the platooning by arranging the vehicles with respect to one another at least in part it is possible to travel in the lee of the wind in order to save fuel. Alternatively, it is also possible to determine only the true wind (by way of example using wind sensors next to the traffic lane) that (in the case of a side wind) ensure that the apparent wind has a component that differs from the travel direction or the travel wind is further strengthened or weakened. This may then by way of example with the knowledge of the vehicle velocity (airflow) be used to specify the respective desired offset.

In this case, it is advantageous that the wind factor that characterizes the wind with respect to its wind speed and wind direction is determined individually for each vehicle in order to determine for each vehicle individually the optimal positioning with the aid of the wind that is actually acting on this vehicle. This is in particular therefore advantageous since the wind conditions on the individual vehicles in the platoon, for example on account of traveling in the lee of the wind, change or may have different effects, by way of example on account of different vehicle bodies of the vehicle respectively traveling ahead.

In order to determine the wind factors, it is preferred that the method in one embodiment uses exclusively sensor data that has been acquired by a steering angle sensor of a steering unit and/or by means of a yaw rate sensor. It is thus possible to ensure a cost-effective design of the components that are necessary for the method, since sensors of this type are generally present in the vehicle and thus additional components are not required. Furthermore, the probability of sensors of the vehicle failing is kept to a minimum if the number of the sensors is minimized. It is thereby possible for the wind factors to be determined in this manner by only one vehicle in the platoon, by way of example the first vehicle. However, it is also possible to determine wind factors individually.

In this case, it is possible with the aid of the actual steering angle and a yaw rate, which is to be expected therefrom, and the currently prevailing actual yaw rate to form a yaw rate difference that is used to determine the wind factor since the wind that is acting on the vehicle causes the driver to perform a certain opposite steering action that is by way of example dependent upon the wind speed and/or the wind direction and that on account of the effective wind does not influence the actual yaw rate fully.

An alternative or supplementary variant of the method provides an airflow sensor that is likewise able to provide data regarding the prevailing wind factors. Furthermore, the airflow sensor may also provide redundant data with regard to the data provided by the steering angle sensor and the yaw rate sensor, wherein it is possible by way of the redundant data both to compensate for sensor malfunctions and also to perform plausibility checks for uncertainties of measurement.

In a preferred embodiment, the desire transverse offset is also determined with the aid of sensor signals that are determined by means of a sensor system, such as for example cameras, radar sensors or ultrasound sensors, with the result that advantageously the maximum permissible desired transverse offset is produced between two vehicles with the aid of a currently prevailing lane width that is determined in dependence upon the sensor signals. Consequently, it is also possible always to make optimal use of the usable lane width of a traffic lane and also to prevent a vehicle of the platoon from leaving the traffic lane in the case of narrow lane widths.

In addition, a desired longitudinal offset between the vehicles may influence the desired transverse offset that is to be determined between the vehicles or conversely, since where appropriate it may be necessary to orient the vehicle differently in the case of a side wind without failing to maintain a minimum interval (longitudinal offset). Since however it is also possible for relevant deviations to occur between the desired longitudinal offset and a currently prevailing actual longitudinal offset, it is also advantageously possible to determine the desired transverse offset on the basis of the actual longitudinal offset so as to reduce the air resistance. When adjusting a desired longitudinal offset, by way of example as a result of the vehicle that is traveling ahead accelerating, it is accordingly possible as the two vehicles subsequently approach one another by way of example for the desired transverse offset to be continuously adjusted to the actual longitudinal offset which is then becoming smaller. Conversely, it is possible to adjust the desired longitudinal offset in dependence upon a changing desired transverse offset if by way of example the traffic lane becomes narrower.

The procedure of optimizing the air resistance in a platoon may have as an objective criterion the minimization of a total air resistance of the entire platoon. The total air resistance of the platoon is thereby produced by way of the addition of the air resistances of the individual vehicles of the platoon. However, it is also possible for the minimization of the air resistance of each individual vehicle in its position in the platoon to be the aim of the method if the minimization of the total air resistance of the platoon is by way of example not the objective criterion. This is by way of example then the case if owing to likewise greatly varying environmental conditions the minimization of the air resistance of the entire platoon requires high computing capacities or the optimized air resistance for individual vehicles is required.

In a preferred embodiment, the method uses the number of vehicles in the platoon in order to divide the desired transverse offset of the vehicles with respect to one another between multiple vehicles in an optimum manner, said desired transverse offset being dependent upon the lane width. Thus, it is possible by way of example for the lane width to be divided between desired transverse offsets of equal sizes with respect to the vehicles respectively traveling directly ahead for at least a part of the vehicles of the platoon. This allocation may be controlled by way of example centrally, by way of example in one of the vehicles of the platoon.

It is preferred that the position of each vehicle of the platoon is also determined with the aid of aerodynamic characteristics of the respective vehicle. In this case, not only are the vehicle height, the vehicle length and the vehicle width relevant but also the vehicle geometric shape within the external dimensions, such as by way of example front or rear air conducting systems, in particular spoilers, the geometric shape of the vehicle body, but also the type of vehicle body is relevant since, by way of example in the case of an identical vehicle geometric shape, a body comprising tarpaulins and mirrors differs aerodynamically from a box body. It is therefore possible to realize a minimization of the total air resistance or also of the individual air resistances in addition to defining the desired transverse offset and/or the desired longitudinal offset in addition by way of the sequence in which the vehicles are arranged one behind the other.

In accordance with a preferred further development, it is possible in addition to adjusting the position to also adjust the desired longitudinal offset and/or the desired transverse offset between two vehicles in dependence upon the aerodynamic characteristics since these may affect the lee of the side wind in particular for the vehicle that is traveling behind and accordingly affect the wind resistance. In order in a most simple and efficient manner to render possible a fuel-efficient operation, it is consequently advantageously possible to take into consideration a further magnitude of influence acting on the wind.

It is preferred that the determined arrangements in other words the desired positions or desired offsets of the vehicles with respect to one another are adjusted in an automated manner in that the desired longitudinal offset is adjusted by way of an automated control of a drive unit and/or of a brake unit and the desired transverse offset is adjusted by way of an automated control of a steering unit. It is hereby possible to realize a particularly precise approximation of the actual longitudinal offset or of the actual transverse offset to the desired longitudinal offset or the desired transverse offset and to realize a particularly fuel-efficient operation, in particular also without the driver having to be in the driving seat or to be alert.

The desired longitudinal offset and the desired transverse offset are thereby preferably determined by the vehicle that is respectively traveling behind. This renders possible an efficient control procedure with a small exchange of data via a communication system between the vehicles. It is possible for this purpose to allocate the first vehicle of the platoon by way of example by default a position on the outermost edge of the traffic lane—in the direction from which the wind is coming—and the vehicles that are traveling behind may in the case of changes in the environmental conditions, in particular the wind conditions, by way of determining an adjusted desired longitudinal offset and desired transverse offset adjust the actual longitudinal offset and the actual transverse offset accordingly to suit the changed environmental conditions without using the communication system. Consequently, it is also possible without additional communication between the vehicles to realize an optimal arrangement of the vehicles with respect to one another.

An alternative variant of the method provides that the desired longitudinal offset and the desired transverse offset is determined by any arbitrary vehicle of the platoon and the desired longitudinal offset and the desired transverse offset are transmitted to the relevant vehicles by means of a communication system. As a consequence, it is possible that only one vehicle in the platoon has to perform centrally the procedure of determining the desired transverse offset and/or the desired longitudinal offset and the other vehicles of the platoon receive the desired longitudinal offsets and desired transverse offsets that have been determined thereby and only adjust the actual longitudinal offset and the actual transverse offset accordingly. It is thereby possible via the communication system to also transmit to the central vehicle the wind factors that have been determined individually in the respective vehicle.

Control arrangements described herein for vehicles, in particular commercial vehicles, include a sensor system, in particular a steering angle sensor, a yaw rate sensor and/or an airflow sensor, for ascertaining wind factors in order to be able to characterize the wind that is prevailing in the vehicle environment. Depending upon the configuration, the sensor system may be arranged on only one of the vehicles, which coordinates the entire platoon, and the wind that is acting on the other vehicles may be estimated by means of algorithms that take into consideration the aerodynamic characteristics of the vehicles. Alternatively, each vehicle may comprise a sensor system of this type in order to ascertain precisely the wind that is prevailing at each individual vehicle.

Furthermore, control arrangements comprise a platooning control unit that uses the wind conditions or wind factors that are determined by the sensor system, likewise determines the apparent wind that arises for each vehicle of the platoon and determines therefrom a desired longitudinal offset and/or a desired transverse offset that is implemented in a controlled manner by a vehicle controller. In this case, the vehicle controller determines from the desired longitudinal offset and/or the desired transverse offset a desired acceleration or a desired steering angle. It is preferred that the platooning control unit and the vehicle controller may also be combined. It is preferred that the control arrangement comprises furthermore a drive unit and/or a brake unit that under the control of the vehicle controller implements the desired longitudinal offset or the desired acceleration and/or the desired transverse offset (steering-braking) and said control arrangement also comprises a steering unit for the automated adjustment of the desired steering angle so as to implement the desired transverse offset.

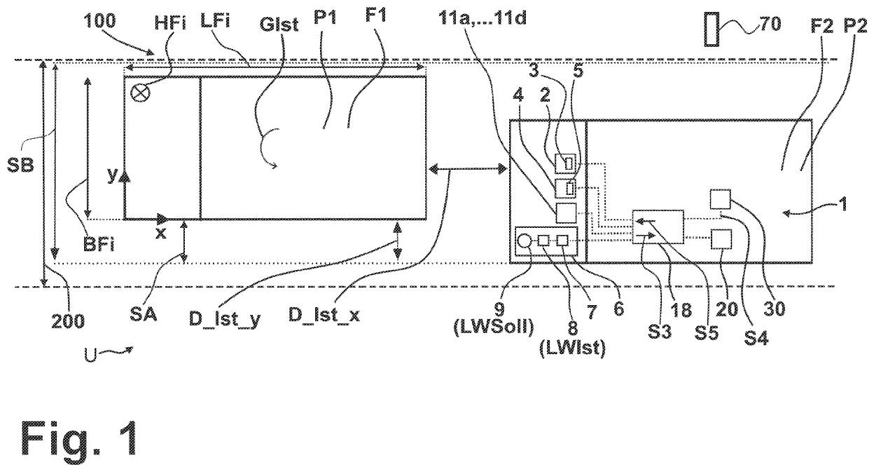

FIG. 1 illustrates schematically two arbitrary vehicles Fi, where i=1, 2, that are moving in a platoon 100 or in a convoy, wherein a first position P1 is allocated to a first vehicle F1 and a second position P2 is allocated to a second vehicle F2 in the platoon 100. It is also possible to provide a number A of more than two vehicles Fi, i=1 . . . , A in the platoon 100 with respective positions Pk, k=1, . . . , A. Furthermore, a traffic lane 200 is illustrated with a lane width SB, wherein the term ‘lane width SB’ is intended to mean the maximal useable area of the traffic lane 200, for example the region between road markings on the traffic lane 200 taking into consideration bulges on the vehicle Fi, by way of example protruding mirrors.

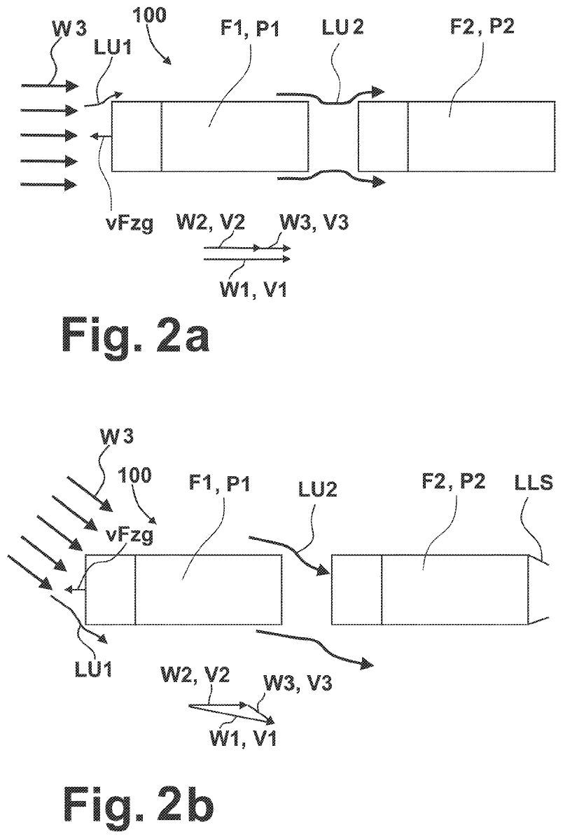

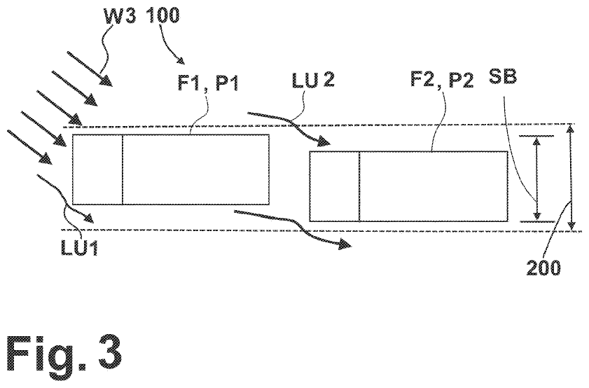

Each of the vehicles Fi may comprise a control arrangement 1 that renders it possible to control in a coordinated manner the respective vehicle Fi within the platoon 100, i.e. to coordinate the movement of the vehicles in such a manner that a flow resistance or air resistance LUi, i=1, . . . , A (cf. FIG. 2a, 2b, 3) that acts on at least one of the vehicles Fi and thus also fuel consumption are reduced. In this case, the air resistance LUi indicates the resistance to which the respective vehicle Fi is subjected by the air that is located in a vehicle environment U around the respective vehicle Fi, wherein the direction of the airflow that causes the air resistance LUi is indicated in each case by an arrow in the FIGS. 2a, 2b, 3. For the sake of clarity, the components of the control arrangement 1 are only illustrated for the second vehicle F2.

A current actual offset of the two vehicles Fi with respect to one another in a y-direction is indicated by an actual transverse offset D_Ist_y. A current offset of the vehicles Fi with respect to one another in an x-direction is indicated by an actual longitudinal offset D_Ist_x, wherein in accordance with this embodiment the actual transverse offset D_Ist_y and the actual longitudinal offset D_Ist_x are indicated with regard to the first vehicle F1 in the first position P1. In other words, the coordinate system used is a vehicle-specific Cartesian coordinate system, the origin of which lies on a front side of the first vehicle F1 and which is oriented as illustrated in FIG. 1. However, the origin may also lie vehicle-specific in the second vehicle F2. The actual transverse offset D_Ist_y may moreover also be indicated starting from the center axes of the two vehicles Fi.

As part of the control arrangement 1, a platooning control unit 20 is provided in each vehicle Fi and said platooning control unit is configured so as to coordinate the respective vehicle Fi within the platoon 100 in that a desired longitudinal offset D_Soll_x and a desired transverse offset D_Soll_y is determined with respect to the respective vehicle Fi or the respective other vehicles Fi in the platoon 100. The platooning control unit 20 may for this purpose refer back in particular to the environmental data S4 that are received by means of a communication system 30 in the vehicle Fi from a vehicle environment U but said platooning control unit may also refer back to condition data S5 that is itself determined in the respective vehicle Fi.

The communication system 30 is used in this case for the wireless transmission of data between the vehicles Fi, that are for example part of the platoon 100, and/or between vehicles Fi and infrastructure units 70 (road signs, traffic guidance systems, etc.), i.e. a wireless communication via a V2V (vehicle-to-vehicle) or a V2I (vehicle-to-infrastructure) connection is ensured, by way of example via WLAN, Bluetooth, DSRC, GSM, UMTS, etc.

The environmental data S4 thereby comprises by way of example current information regarding the other vehicles Fi in the platoon 100, in particular current velocities, accelerations, forthcoming braking maneuvers, etc. but also vehicle characteristics of the individual vehicles Fi in the platoon 100, for example maximal velocities or maximal accelerations or decelerations, and forthcoming traffic conditions, for example speed restrictions, road works, accidents, etc. In addition, it is also possible to involve aerodynamic characteristics AE of the other vehicles Fi. In this case, the aerodynamic characteristics AE being taken into consideration may be by way of example a vehicle height HFi, a vehicle length LFi and a vehicle width BFi, the presence and the adjustment of air conducting systems LLS, in particular spoilers, and a characteristic of a vehicle body of the vehicle, by way of example a geometric shape of the vehicle body or also the type of the vehicle body.

On account of the data exchange between the vehicles Fi of a platoon 100 and/or the infrastructure units 70, it is possible for the platooning control unit 20 to define a smaller desired longitudinal offset D_Soll_x than usual between the vehicles Fi, on the basis of which the actual longitudinal offset D_Ist_x is to be adjusted since minimum intervals may be selected to be smaller by way of coordinating the vehicles Fi and/or the infrastructure units 70. Consequently, the air resistance at individual vehicles Fi in the platoon 100 LUi may be reduced to a greater extent than in the case of uncoordinated vehicles that are traveling one behind the other.

The condition data S5 which the platooning control unit 20 refers back to may be obtained in particular by means of a sensor system or sensors. For this purpose, it is possible by way of example to provide sensors for determining an actual yaw rate GIst, for example yaw rate sensors 11a. Furthermore, the sensor system may comprise interval sensors 11b, such as for example radar sensors or ultrasound sensors in order to render it possible to determine the currently prevailing actual longitudinal offset D_Ist_x and the actual transverse offset D_Ist_y. Furthermore, it is possible by way of example to provide cameras 11c for recognizing traffic lanes 200 or for deducing the useable lane width SB.

Furthermore, airflow sensors 11d may be provided so as to ascertain a wind factor, wherein the wind factor characterizes wind conditions of a wind that is acting on the respective vehicle Fi, i.e. the air that is moving in the vehicle environment U. The wind that is acting on the respective vehicle Fi is in this case an apparent wind W1 that in accordance with FIGS. 2a and 2b is composed of an airflow W2 and a true wind W3 by way of a vector addition. Accordingly, a second vector V2 is allocated to the airflow W2 that flows parallel to the x-direction or to the direction of movement of the vehicle Fi and is dependent upon a vehicle velocity vFzg and a third vector V3 is allocated to the true wind W3 that corresponds to the meteorological wind. A first vector V1 that is allocated to the apparent wind W1 is then obtained from a vector addition of the second and the third vectors V2, V3. The length and the direction of the vectors V1, V2, V3 is defined by the velocity (wind strength) or the direction of the respective wind W1, W2, W3.

It is consequently possible to indicate as wind factors by way of example a wind direction WR and/or a wind speed vW that define the direction or the speed of the apparent wind W1 that actually acts on the respective vehicle Fi. It is possible using the airflow sensors 11d to precisely determine the wind factors vW, WR of the apparent wind W1. The air resistance LUi that is acting on the respective vehicle Fi is in this case in particular dependent upon these wind factors vW, WR.

Alternatively, the wind factors vW, WR may also be determined from the actual yaw rate GIst and a current actual steering angle LWIst that is measured via a steering angle sensor 8, in that a yaw rate Gp that is to be expected on account of the current actual steering angle LWIst is compared with the currently prevailing actual yaw rate GIst. A yaw rate difference dG, i.e. a difference between two yaw rates Gist, Gp, is influenced by the wind direction WR and the wind speed vW of the true wind W1 with the result that the wind direction WR and the wind speed vW is obtained via a calibration procedure from the yaw rate difference dG. In the case of a headwind or a tailwind (true wind W1), i.e. parallel to the x-direction, a yaw rate difference dG of zero is accordingly to be expected and in the case of a side wind (true wind W1), i.e. parallel to the y-direction, a yaw rate difference dG of greater than zero is to be expected since the driver counteracts the side wind by way of counter-steering. In the case of a side wind, the actual yaw rate GIst does not change as a result of purely counter-steering, however, on account of the counter-steering the yaw rate Gp that is to be expected becomes greater or smaller depending upon the wind direction WR. It is also possible to take into consideration further effects that trigger a change in the yaw rate difference dG but are not as a result of the prevailing wind conditions, by way of example an inclined road. These further effects may be detected by way of example via the stability system (ESC) and compensated for accordingly.

Furthermore, the procedures of determining the wind factors vW, WR via the yaw rate difference dG and via the airflow sensors 11d may also be checked for plausibility against one another.

In dependence upon at least one item of this condition data S5, in particular in dependence upon the wind factors vW, WR, the platooning control unit 20 may define a desired transverse offset D_Soll_y for the respective vehicle Fi relative to the vehicle Fi that is traveling ahead in order to optimize the air resistance LUi that is acting on the vehicles Fi in the platoon 100. It is also possible thereby to take into consideration the predetermined desired longitudinal offset D_Soll_x or the current actual longitudinal offset D_Ist_x, i.e. the extent to which two vehicles Fi move closely to one another, since as a consequence the effective area in particular of the true wind W2 that is acting on the vehicle Fi that is traveling behind may change slightly.

Fundamentally, it is also already possible to transmit a desired longitudinal offset D_Soll_x and/or a desired transverse offset D_Soll_y between the vehicles Fi as environmental data S4 via the communication system 30, i.e. a different vehicle Fi in the platoon 100 specifies how by way of example the first vehicle F1 that is traveling ahead is to be oriented with respect to the second vehicle F2 that is traveling behind (or conversely), in particular with respect to the desired transverse offset D_Soll_y. This may then be expedient by way of example if the second (or respective other) vehicle F2 identifies changed or other wind factors vW, WR that make it necessary to change the actual transverse offset D_Ist_y by controlling the first vehicle F1 and whilst using the full lane width SB in order to continue traveling in a fuel-efficient manner. Furthermore, it is possible in the case of a defective sensor system or in the absence of a sensor system, i.e. lack of information regarding the wind factors vW, WR, for a different vehicle Fi to specify a desired transverse offset D_Soll_y. In addition, it is possible by coordinating multiple vehicles Fi to also realize an optimal use of the lane width SB, in particular if more than two vehicles Fi are located in a platoon 100 i.e. where A>2.

In this case, the platooning control unit 20 in the relevant vehicle Fi transmits therefore only the desired longitudinal offset D_Soll_x that is received from another vehicle Fi via the communication system 30 and/or the received desired transverse offset D_Soll_y for implementation in the own vehicle Fi or outputs to the communication system 30 a desired longitudinal offset D_Soll_x, which is determined on account of the wind factors vW, WR, and/or the desired transverse offset D_Soll_y with the result that an instruction to change the orientation may be transmitted to another vehicle Fi in the platoon 100. For a simpler implementation of a desired transverse offset D_Soll_y by a vehicle Fi that is traveling ahead to a vehicle Fi that is traveling behind, it is possible by way of example also to indicate a lane interval SA in one or both directions, wherein the lane interval SA indicates the interval between the respective vehicle Fi and the maximal useable area to the side of the traffic lane 200, which is defined by the lane width SB, and automatically leads to the predetermined desired transverse offset D_Soll_y.

The control arrangement 1 in the respective vehicle Fi comprises in accordance with the embodiment in FIG. 1 the following components, which render it possible to control the respective vehicle on the basis of the environmental data S4 and the condition data S5 in a coordinated manner by the platooning control unit 20 within the platoon 100:
a drive unit 2 that comprises a drive control unit 3 for controlling a motor and/or a transmission of the respective vehicle Fi, wherein the motor and/or the transmission may be controlled in dependence upon a desired acceleration aSoll that is predetermined for the drive control unit 3 for a positive acceleration of the vehicle Fi or for a negative acceleration (motor braking).
a brake unit 4 that comprises a brake control unit 5 for controlling the brakes of the respective vehicle Fi, by way of example service brakes, in order to be able to implement a predetermined negative desired acceleration aSoll.

A steering unit 6 comprises a steering angle sensor 8 for measuring the currently adjusted actual steering angle LWIst and a steering actuator 9 for adjusting an automated predetermined desired steering angle LWSoll. The actual steering angle LWIst that is ascertained from the steering angle sensor 8 and output may be transmitted to a steering control unit 7 and the desired steering angle LWSoll may be output to the steering actuator 9 by the steering control unit 7 in order by way of example to initiate an automated predetermined steering procedure.

In the illustrated embodiment, each of the mentioned units 2, 4, 6 and the sensor system 11a . . . 11d, the platooning control unit 20 and the communication system 30 are connected to a central vehicle controller 18 for the purpose of conducting signals with the result that the vehicle controller 18 may process and/or transmit the environmental data S4 and the condition data S5 as actual variables. The platooning control unit 20 and the vehicle controller 18 may also be combined, by way of example within the scope of software expansion. The vehicle controller 18 may also be combined with a conventional interval control system, expanded in order to provide the possibility of also performing a steering procedure in order also to adjust the desired transverse offset D_Soll_y.

In dependence upon the environmental data S4 and the condition data S5, determined or defined control data S3 that are used as desired variables for controlling the respective vehicles Fi in the platoon 100 in a coordinated manner may be subsequently output by the vehicle controller 18 to the relevant unit 2, 4, 6 with the result that these units may perform their adjustments accordingly with the aid of the control data S3 in order to implement the desired variables. The vehicle controller 18 is consequently used as a central hub for receiving and distributing the individual ascertained variables. In detail, this may occur by way of example as follows:

The platooning control unit 20 receives the environmental data S4 and the condition data S5 from the vehicle controller 18 in the above described manner. The platooning control unit 20 determines from the environmental data S4 and the condition data S5 the desired longitudinal offset D_Soll_x and the desired transverse offset D_Soll_y with which the respective vehicle Fi reduces its air resistance LUi and/or also the air resistance LUi of another vehicle Fi and/or a total air resistance GLU of the platoon 100. The total air resistance GLU is obtained in this case from the sum of the individual air resistances LUi. In this case, it is particularly taken into consideration how at least two vehicles Fi in the platoon 100 are to be optimally oriented with respect to one another with the result that the vehicle Fi that is traveling ahead at least in part blocks the effective wind having a component in the y-direction and said wind acts to a lesser extent on the vehicle Fi that is traveling behind. It is thereby further possible via the lane width SB to take into consideration how far to the side a vehicle Fi may deviate to the side without in so doing arriving on the adjacent traffic lane 200 or impairing the surrounding traffic.

The desired transverse offset D_Soll_y and/or the desired longitudinal offset D_Soll_x may be defined for this purpose in dependence upon the wind factors vW, WR by way of example via a calibration procedure. In other words, a desired transverse offset D_Soll_y and/or the desired longitudinal offset D_Soll_x are allocated to the relevant determined wind factors vW, WR, in particular the wind direction WR, via a characteristic curve or a characteristic performance map. The calibration procedure may in this case take into consideration further variables that are associated with the wind W1, W2, W3, by way of example the defined desired longitudinal offset D_Soll_x or the actual longitudinal offset D_Ist_x and also aerodynamic characteristics AE of the respective vehicle Fi. In this case, it is possible to take into consideration as the aerodynamic characteristics AE by way of example the vehicle height HFi, the vehicle length LFi and the vehicle width BFi, the presence and the adjustment of the air conducting systems LLS, by way of example spoilers, and a characteristic of a vehicle body of the vehicle, by way of example a geometric shape of the vehicle body or also the type of the vehicle body. In other words, the desired offsets D_Soll_y, D_Soll_x may also be defined with regard to how well the respective vehicle Fi may block the wind W1, W2, W3 in particular for the vehicle that is traveling behind Fi.

FIGS. 2a, 2b illustrate by way of example a platoon 100 comprising two vehicles Fi and an apparent wind W1 having different wind factors vW, WR. If wind conditions prevail for the two vehicles Fi for which the wind direction WR of the apparent wind W1 is oriented parallel to the airflow W2, i.e. is oriented parallel to the x-direction (cf. FIG. 2a) or in the absence of a wind, the lowest air resistance LUi acts on the vehicles Fi of the platoon 100 if the vehicles Fi move with respect to one another with an actual transverse offset D_Ist_y of zero. This may be detected by the platooning control unit 20 with the aid of the condition data S5, whereupon a desired transverse offset D_Soll_y of zero is defined.

However, if the wind direction WR of the apparent wind W1, as illustrated in FIG. 2b, has on account of a side wind (true wind W3) a component that is deviating from the airflow W2 and is in the y-direction, i.e. if the wind direction WR of the apparent wind W1 is no longer oriented parallel to the x-direction, it is disadvantageous for the air resistance LUi to drive the vehicle Fi with an actual transverse offset D_Ist_y of zero. As illustrated, the airflow between the vehicles Fi is namely intensified and consequently the air resistance LU2 increases in particular to the second vehicle F2 that is traveling behind, wherein the first vehicle F1 possibly also experiences a slightly increased air resistance LU1 on account of a type of suction effect. This is disadvantageous in the case of conventional methods according to the prior art, in which the actual transverse offset D_Ist_y is only adjusted after the manual specification by the driver, which may lead to driving situations that are not optimal as shown in FIG. 2b.

It is more advantageous to drive in a slightly offset manner according to the method, as illustrated in FIG. 3, in the case of side wind conditions for the air resistance LUi both for the first vehicle F1 in the first position P1 and also for the second vehicle F2 that is traveling behind in the second position P2. The airflow as illustrated is less between the vehicles Fi than in comparison to the driving situation in FIG. 2b in which the vehicles Fi are traveling with an actual transverse offset D_Ist_y of zero with the result that the air resistance LUi is reduced in comparison to FIG. 2b and consequently the total air resistance GLU=LU1+LU2 is reduced.

In order to further optimize the air resistance LUi, GLU, it is possible via the environmental data S4 to also specify the positions Pk of the respective vehicle Fi in the platoon 100, wherein the position Pk of each vehicle Fi in the platoon 100 is defined by way of example with the aid of the aerodynamic characteristics AE of the respect vehicle Fi.

The desired transverse offset D_Soll_y and the desired longitudinal offset D_Soll_x, which are determined according to this system in the platooning control unit 20, and where appropriate also the lane interval SA that is obtained therefrom are transmitted to the vehicle controller 18 which determines therefrom a vehicle desired acceleration aSoll and a desired steering angle LWSoll taking into consideration the current actual longitudinal offset D_Ist_x or the actual transverse offset D_Ist_y, the actual steering angle LWIst and also from limit values. These are transmitted as control data S3 to the respective unit 2, 4, 6 with the result that it is possible for them to ensure the control data S3 are implemented or the desired transverse offset D_Soll_y and the desired longitudinal offset D_Soll_x are adjusted. If it is not possible to adjust a desired transverse offset D_Soll_y on account of the lane width SB, it is possible to inform the vehicle Fi that is traveling ahead or the vehicles Fi that are respectively traveling ahead via the communication system 30 also for example in the form of the lane interval SA that said vehicle or vehicles moves or move in the relevant direction within the lane width SB as a result of an intervention in the steering procedure.

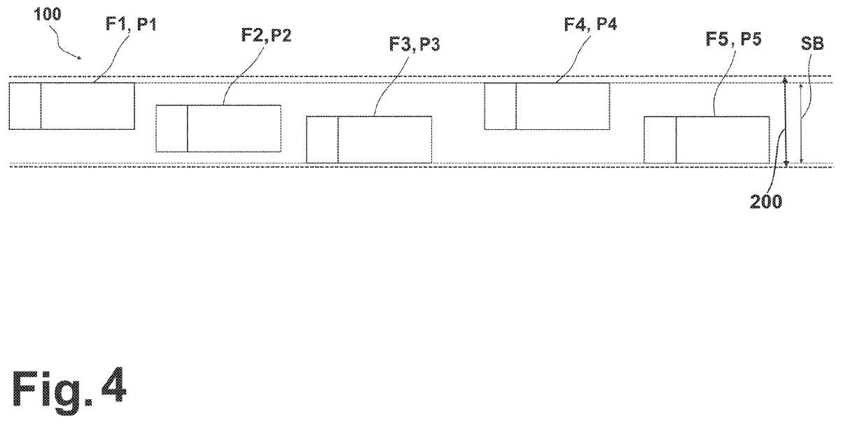

In order to optimize the air resistance LUi or the entire air resistance GLU of a platoon 100 with preferably more than three vehicles Fi, i.e. A>3, it may be necessary that the desired transverse offsets D_Soll_y between the individual vehicles Fi are selected in such a manner as illustrated in FIG. 4. FIG. 4 illustrates by way of example a platoon 100 with five vehicles Fi.

As illustrated, the first vehicle F1 with the first position P1 and the third vehicle F3 with the third position P3 use the maximal useable lane width SB with the result that it is not possible for the fourth vehicle F4 in the fourth position P4 to increase its offset in the y-direction. Therefore, the platooning control unit 20 allocates the fourth vehicle F4 in the fourth position P4 a desired transverse offset D_Soll_y of zero with respect to the first vehicle F1 in the first position P1 or a corresponding greater desired transverse offset D_Soll_y with respect to the third vehicle F3 in the third position P3. As a consequence, by way of analyzing the lane width SB and the prevailing wind conditions of the apparent wind W1, instructions are issued to the fourth vehicle F4 that said fourth vehicle is to make full use of the traffic lane 200 on the right-hand side, although as a result the air resistance LU4 of the fourth vehicle F4 in the fourth position P4 is increased in comparison to a desired transverse offset D_Soll_y of zero with respect to the third vehicle F3 in third position P3. This serves to minimize the total air resistance GLU of the entire platoon 100 since hereby the fifth vehicle F5 in the fifth position P5 may in turn be offset in the y-direction with respect to the fourth vehicle F4 in the fourth position P4. The extent to which the air resistance LU5 of the fifth vehicle F5 is reduced is thus greater that the reduction of the air resistances LU4, LU5 of the fourth and fifth vehicles F4, F5 if these have each been moved respectively with a desired transverse offset D_Soll_y of zero with respect to the third vehicle F3. The total air resistance GLU of the platoon 100 is thus minimized, wherein it is not optimized for the fourth vehicle F4 in the fourth position P4.

The specification for an arrangement of this type of the vehicles Fi may be created in this case centrally in dependence upon the wind conditions of the apparent wind W1, in that the desired transverse offset D_Soll_y by way of example in dependence upon the number A of vehicles Fi in the platoon 100 and the lane width SB are determined centrally and are received and implemented as environmental data S4 via the communication system 30 in the individual vehicles Fi. Or each vehicle Fi determines the desired transverse offset D_Soll_y itself, wherein upon detection that the lane width SB is exceeded, the respective other side of the traffic lane 200 is controlled or however a corresponding specification is output to the vehicle Fi that is traveling ahead or the vehicles Fi that are traveling ahead to adjust the respective actual transverse offset D_Ist_x and/or if possible to make full use of the traffic lane 200.

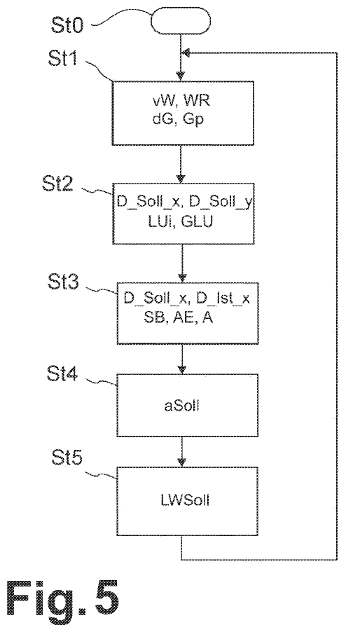

FIG. 5 illustrates by way of example method steps St0 to St5 for arranging or coordinating vehicles Fi in a platoon 100. In an initial method step St0, the method is started by way of example by virtue of the fact that a vehicle Fi has joined a platoon 100, i.e. a platooning mode has been activated.

In a first method step St1, the wind conditions of the wind factors vW, WR that characterize the apparent wind W1 are determined via the actual steering angle LWIst and the actual yaw rate GIst or the yaw yate difference dG, which is obtained from the difference between the actual yaw rate GIst and the expected yaw rate Gp, for at least one of the vehicles Fi of the platoon 100 and/or by way of airflow sensors 11d on one of the vehicles Fi of the platoon 100. The wind factors vW, WR that are determined in the first step St′ are used in a second step St2 for determining the desired transverse offset D_Soll_y and/or the desired longitudinal offset D_Soll_x, which is to be adjusted between two vehicles Fi of the platoon 100, in order to optimize the air resistance LUi of the individual vehicles Fi in the platoon 100 and/or the total air resistance GLU of all the vehicles Fi with respect to the prevailing wind conditions of the apparent wind W1.

In this case, in a third step St3 it is also possible, as already described, in order to determine the desired transverse offset D_Soll_y to use the desired longitudinal offset D_Soll_x, which is obtained on the basis of the environmental data S4, and/or the currently prevailing actual longitudinal offset D_Ist_x and/or the lane width SB and/or the aerodynamic characteristics AE and/or the number A of the vehicles Fi in the platoon 100. The desired transverse offset D_Soll_y may be determined in the respective vehicle Fi itself or however centrally and subsequently transmitted to the respective vehicle Fi for implementation.

In a fourth step St4, the drive unit 2 or the brake unit 4 of the relevant vehicle Fi in the platoon 100 are controlled using a desired acceleration aSoll in order to adjust the actual longitudinal offset D_Ist_x to the desired longitudinal offset D_Soll_x.

In a fifth step St5, the steering unit 6 of the relevant vehicle Fi in the platoon 100 is controlled using the desired steering angle LWSoll so as to adjust the actual transverse offset D_Ist_y to the desired transverse offset D_Soll_y.

The method jumps back to the first step St1 as long as the vehicle Fi is located in the platooning mode.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Control arrangement
2 Drive unit
3 Drive control unit
4 Brake unit
5 Brake control unit
6 Steering unit
7 Steering control unit
8 Steering angle sensor
9 Steering actuator
11a Yaw rate sensor
11b Interval sensors
11c Cameras
11d Airflow sensors
18 Vehicle controller
20 Platooning control unit
30 Communication system
70 Infrastructure units
100 Platoon/Convoy
200 Traffic lane
A Number
aSoll Desired acceleration
AE Aerodynamic characteristics
BFi Vehicle width
dG Yaw rate difference
D_Ist_x Actual longitudinal offset
D_Ist_y Actual transverse offset
D_Soll_x Desired longitudinal offset
D_Soll_y Desired transverse offset
Fi Vehicle, i=1, 2, 3, . . .
GIst Actual yaw rate
Gp Expected yaw rate
GLU Total air resistance
HFi Vehicle height
LFi Vehicle length
LLS Air conducting system
LUi Air resistance, i=1, 2, 3, . . .
LWIst Actual steering angle
LWSoll Desired steering angle
Pk Position k, k=1, 2, 3, . . .
S3 Control data
S4 Environmental data
S5 Condition data
SA Lane interval
SB Lane width
U Vehicle environment
V1 First vector, Wind W1 allocated
V2 Second vector, Wind W2 allocated
V3 Third vector, Wind W3 allocated
vFzg Vehicle velocity
W1 Apparent wind
W2 Airflow
W3 True wind
W Wind factor
WR Wind direction
vW Wind speed
St1, St2, St3, St4, St5 Method steps

1. A method for arranging individual vehicles in a platoon, the method comprising:
determining a desired longitudinal offset and/or a desired transverse offset for at least one respective individual vehicles, by:
determining at least one wind factor that characterizes how prevailing wind in a vehicle environment acts on the at least one respective individual vehicle of the platoon, and
specifying the desired transverse offset and/or the desired-longitudinal offset for the at least one respective individual vehicle of the platoon in dependence upon the at least one wind factor in such a manner that an air resistance acting on the at least one respective individual vehicle of the platoon reduces under the prevailing wind.

2. The method as claimed in claim 1, wherein the at least one wind factor characterizes (i) an apparent wind composed of a prevailing airflow that is dependent upon a vehicle velocity of the at least one respective individual vehicle, and (ii) a true wind prevailing in the vehicle environment, or
wherein the at least one wind factor characterizes only the true wind prevailing in the vehicle environment.

3. The method as claimed in claim 1, wherein a wind speed that characterizes the prevailing wind and/or a wind direction are determined as wind factors with which the prevailing wind acts on the at least one respective individual vehicle.

4. The method as claimed in claim 3, wherein the wind speed and/or the wind direction are determined with aid of an actual steering angle and an actual yaw rate in the at least one respective individual vehicle of the platoon.

5. The method as claimed in claim 4, wherein an expected yaw rate is determined from the actual steering angle and the wind speed and/or the wind direction are determined from a yaw rate difference between the expected yaw rate and the actual yaw rate.

6. The method as claimed in claim 3, wherein the wind speed and/or the wind direction are determined via airflow sensors on the at least one respective individual vehicle.

7. The method as claimed in claim 4, wherein the wind speed, which is determined via airflow sensors, and/or the wind direction, are checked for plausibility against a wind speed determined from the actual steering angle, the actual yaw rate, and/or the wind direction.

8. The method as claimed in claim 1, wherein the wind factors are determined individually for each individual vehicle of the platoon.

9. The method as claimed in claim 1, wherein the desired transverse offset is determined in addition in dependence upon a lane width.

10. The method as claimed in claim 1, wherein the desired transverse offset is determined in addition in dependence upon a currently prevailing actual longitudinal offset and/or in dependence upon the desired longitudinal offset, and/or the desired longitudinal offset is determined in addition in dependence upon the desired transverse offset.

11. The method as claimed in claim 1, wherein the desired transverse offset and/or the desired longitudinal offset is determined in dependence upon the wind conditions in such a manner that a total air resistance is minimized for the entire platoon, wherein the total air resistance is obtained from a sum of respective air resistances that are acting on respective individual vehicles.

12. The method as claimed in claim 1, wherein the desired transverse offset is determined in dependence upon a number of vehicles in the platoon.

13. The method as claimed in claim 1, wherein the desired transverse offset and/or the desired longitudinal offset and/or a position of the vehicles in the platoon is determined in dependence upon aerodynamic characteristics of the at least one respective individual vehicle, wherein the aerodynamic characteristics include at least one characteristic that is selected from the group that comprises: a vehicle height, a vehicle length, a vehicle width, the presence of air conducting systems, and a characteristic of a vehicle body of the at least one respective individual vehicle.

14. The method as claimed in claim 1, wherein the defined desired transverse offset is automatically adjusted via a steering unit and/or a brake unit in the respective vehicle and/or the defined desired longitudinal offset is automatically adjusted via a drive unit and/or the brake unit in the respective vehicle.

15. The method as claimed in claim 1, wherein the desired transverse offset and/or the desired longitudinal offset is determined in the at least one respective individual vehicle, which is respectively traveling behind of two vehicles.

16. The method as claimed in claim 1, wherein the desired transverse offset and/or the desired longitudinal offset is determined centrally in an arbitrary vehicle of the platoon and the determined desired transverse offsets and/or the desired longitudinal offsets transmitted via a communication system.

17. A control arrangement for a vehicle, the control arrangement comprising:
a sensor system for detecting at least one wind factor, wherein the wind factor characterizes how prevailing wind in a vehicle environment acts on at least one respective vehicle of a platoon of vehicles, and
a platooning control unit configured to determine a desired longitudinal offset and/or a desired transverse offset in dependence upon the ascertained wind factor.

18. The control arrangement as claimed in claim 17, wherein the control arrangement furthermore comprises:
a drive unit and/or a brake unit configured to adjust a desired acceleration in dependence upon the determined desired longitudinal offset and/or the desired transverse offset, and
a steering unit configured to automatically adjust a desired steering angle in dependence upon the determined desired transverse offset.

19. The control arrangement as claimed in claim 18, wherein the desired acceleration and the desired steering angle are determined in a vehicle controller in dependence upon the determined desired longitudinal offset or upon the desired transverse offset.

20. A vehicle, having a control arrangement as claimed in claim 17.
